(19) United States
(12) Patent Application Publication
(10) Pub. No.: US 2009/0301474 A1
(43) Pub. Date: Dec. 10, 2009

(54) HEAT AND MOISTURE EXCHANGE UNIT WITH RESISTANCE INDICATOR

(76) Inventors: Neil Alex Korneff, Diamond Bar, CA (US); Rebecca Ann Wilday, Riverside, CA (US)

Correspondence Address: DICKE, BILLIG & CZAJA, PLLC;ATTN: CFN MATTERS, 100 SOUTH FIFTH STREET, SUITE 2250, MINNEAPOLIS, MN, 55402, US

(21) Appl. No.: 12/133,887

(22) Filed: Jun. 5, 2008

(51) Int. Cl. A62B 9/00

(52) U.S. Cl. 128/201.13

(57) ABSTRACT

A heat and moisture exchange (HME) unit including a housing, a heat and moisture retaining media (HM media), and a resistance indicator. The housing forms a first port, a second port, and an intermediate section. The intermediate section extends between the first and second ports, and defines a flow path fluidly connecting the first and second ports. The HM media is maintained within the intermediate section along the flow path. The resistance indicator is carried by the housing and is fluidly connected to the first port. In this regard, a visual appearance of the resistance indicator changes as a function of pressure within the housing to visually alert a caregiver as to possible existence of an excessive pressure differential condition within the HME unit.

### BACKGROUND

The present disclosure relates to a heat and moisture exchange (“HME”) unit useful with a patient breathing circuit. More particularly, the HME unit of the present disclosure is connectable to a breathing circuit and provides a visual indication of a functional status of the HME unit.

The use of ventilators and breathing circuits to assist in patient breathing is well known in the art. The ventilator and breathing circuit provide mechanical assistance to patients who are having difficulty breathing on their own. During surgery and other medical procedures, the patient is often connected to a ventilator to provide respiratory gases to the patient. One disadvantage of such breathing circuits is that the delivered air does not have a humidity level and/or temperature appropriate for the patient's lungs.

In order to provide air with desired humidity and/or temperature to the patient, an HME unit can be fluidly connected to the breathing circuit. As a point of reference, “HME” is a generic term, and can include simple condenser humidifiers, hygroscopic condenser humidifiers, hydrophobic condenser humidifiers, etc. In general terms, HME units consist of a housing that contains a layer of heat and moisture retaining media or material (“HM media”). This material has the capacity to retain moisture and heat from the air that is exhaled from the patient's lungs, and then transfer the captured moisture and heat to the ventilator-provided air of the inhaled breath. The HM media can be formed of foam or paper or other suitable materials that are untreated or treated, for example, with hygroscopic material.

While the HME unit addresses the heat and humidity concerns associated with ventilator-provided air in a breathing circuit, other drawbacks may exist. For example, it is fairly common to introduce aerosolized medication particles into the breathing circuit (e.g., via a nebulizer) for delivery to the patient's lungs. Where an HME unit is present in the breathing circuit, however, the medication particles will not readily traverse through the HM media and thus not be delivered to the patient. In addition, the HM media can become clogged with the droplets of liquid medication, in some instances leading to an elevated resistance of the HME unit. One approach for addressing these concerns is to remove the HME unit from the breathing circuit when introducing aerosolized medication. This is time consuming and subject to errors, and can result in the loss of recruited lung volume when the circuit is depressurized. Alternatively, various HME units have been suggested that incorporate intricate bypass structures/valves that selectively and completely isolate the HM media from the air flow path.

An additional concern arising during use of a patient breathing circuit is occurrences of overt resistance to air flow/pressure, and the corresponding identification and correction of the problem. As a point of reference, various, unexpected circumstances can arise in which air flow and/or pressure through the breathing circuit is overtly restricted. For example, where the HM media of the HME unit becomes clogged with particles, air flow through the HME unit may be overly restricted. Other obstructions along the breathing circuit (or within the patient) can also form over time. Regardless of the cause, unexpected air flow and/or pressure resistance in the breathing circuit must be addressed as soon as possible so as to ensure uninterrupted breathing assistance. Extensive time and skill of the caregiver is required to manually determine where unexpected resistance in a patient breathing circuit is occurring, due to the number of discrete components and because a patient breathing circuit has dynamic pressures due to the inhalation and exhalation breathing cycles, coughing, etc. Thus, an under-performing HME unit is not self-evident. Conversely, where the HME unit is incorrectly identified as the problematic component and removed from the circuit, time and recruited lung volume is lost.

### SUMMARY

Some aspects in accordance with the present disclosure relate to a heat and moisture exchange (HME) unit including a housing, a heat and moisture retaining media (HM media), and a resistance indicator. The housing forms a first port, a second port, and an intermediate section. The intermediate section extends between the first and second ports, and defines a flow path fluidly connecting the first and second ports. The HM media is maintained within the intermediate section along the flow path. The resistance indicator is carried by the housing and is fluidly connected to the first port. In this regard, a visual appearance of the resistance indicator changes as a function of pressure within the housing. With this configuration, then, the resistance indicator can visually alert a caregiver as to existence of an excessive pressure or pressure differential condition within the HME unit. In some embodiments, the resistance indicator is configured to change in visual appearance when a pressure differential within the housing exceeds a pre-determined value for a pre-determined time period. In some embodiments, the pre-determined value is 5 cm water and the pre-determined time period is 0.5 second. In other embodiments, the resistance indicator includes a membrane that is positioned within the housing so as to overtly deflect in response to an excessive pressure differential condition, with the housing adapted to facilitate a caregiver visually perceiving this deflection.

Other aspects in accordance with principles of the present disclosure relate to methods of providing respiratory assistance to a patient. The method includes providing an HME unit including a housing, an HM media, and a resistance indicator. The housing forms a ventilator-side port, a patient-side port, and an intermediate section defining a flow path fluidly connecting the ports. The HM media is disposed along the flow path. The resistance indicator is carried by the housing, and is fluidly connected to the ventilator-side port. With this in mind, the ventilator-side port is connected to a source of gas, whereas the patient-side port is connected to a patient. The source of gas is operated to deliver air flow to the HME unit. In connection with the delivery of air flow, a caregiver is alerted, via the resistance indicator, to an excessive pressure differential condition at the HME unit. In some embodiments, alerting the caregiver includes changing a visual appearance of the resistance indicator when a pressure differential within the HME unit exceeds a pre-determined value.

Other aspects in accordance with principles of the present disclosure relate to methods of manufacturing an HME unit. The method includes providing a housing forming a first port, a second port, and an intermediate section. An HM media is assembled within the housing along a flow path fluidly connecting the first and second ports. A resistance indicator is assembled to the housing such that the resistance indicator is fluidly connected to the first port. In this regard, the resistance indicator is configured to effectuate a change in visual appearance as a function of pressure within the housing. In some embodiments, the housing is formed of a plastic material, with the method of manufacture further including polishing a portion of a wall of the housing adjacent the resistance indicator to render the wall portion sufficiently transparent for viewing of the resistance indicator from an exterior of the HME unit.

### BRIEF DESCRIPTION OF THE DRAWINGS

FIG. 1 is a simplified illustration of an example patient breathing circuit with which an HME unit in accordance with principles of the present disclosure is useful;

FIG. 2 is a simplified illustration of another example breathing circuit with which an HME unit in accordance with principles of the present disclosure is useful;

FIG. 3 is a perspective view of an HME unit in accordance with principles of the present disclosure;

FIGS. 4A and 4B are a longitudinal cross-sectional view of the HME unit of FIG. 3, illustrating optional internal flow paths;

FIG. 5A is a perspective view of the HME unit of FIG. 3, with a portion cutaway to illustrate a resistance indicator;

FIG. 5B is an enlarged view of a portion of the view of FIG. 5A;

FIG. 5C is a longitudinal cross-sectional view of the HME unit of FIG. 3, further illustrating the resistance indicator;

FIG. 6A is a perspective view of a membrane component of the resistance indicator of FIG. 5A;

FIG. 6B is a cross-sectional view of the membrane of FIG. 6A in a first, initial state;

FIG. 6C is a cross-sectional view of the membrane of FIG. 6A in a second, triggered state.

FIGS. 7A and 7B are cross-sectional views of the membrane of FIG. 6A and a flag component of the resistance indicator in first and second states;

FIG. 8A is a perspective view of the HME unit of FIG. 3, with a portion cutaway, illustrating the resistance indicator in an initial or first state;

FIG. 8B is a lateral cross-sectional view of the HME unit of FIG. 3, illustrating the resistance indicator in an initial or first state;

FIG. 9A is a perspective view, with a portion cut-away, of an HME unit including another resistance indicator in accordance with principles of the present disclosure in an initial state;

FIG. 9B is an enlarged view of a portion of the HME unit of FIG. 9A;

FIG. 9C is a perspective view, with a portion cut-away, of the HME unit of FIG. 9A illustrating the resistance indicator in a triggered state;

FIG. 10A is a top view of the resistance indicator of FIG. 9A;

FIG. 10B is a cross-sectional view of the resistance indicator of FIG. 10A in the initial state;

FIG. 10C is a cross-sectional view of the resistance indicator of FIG. 10A in the triggered state;

FIG. 11A is a longitudinal, cross-sectional view of the HME unit of FIG. 9A in a bypass mode and the resistance indicator in the initial state;

FIG. 11B is a longitudinal, cross-sectional view of the HME unit of FIG. 9A in an HME mode and the resistance indicator in the triggered state;

FIGS. 12A and 12B are cross-sectional views illustrating portions of another resistance indicator in accordance with the present disclosure and useful as part of the HME unit of FIG. 1;

FIGS. 13A and 13B are cross-sectional views illustrating portions of another resistance indicator in accordance with aspects of the present disclosure and useful as part of the HME unit of FIG. 1;

FIG. 14A is a cross-sectional view illustrating portions of another resistance indicator useful as part of an HME unit in accordance with principles of the present disclosure;

FIG. 14B is a simplified top view of the resistance indicator of FIG. 14A; and

FIG. 15 is a simplified cross-sectional view illustrating portions of another resistance indicator useful as part of an HME unit in accordance with principles of the present disclosure.

### DETAILED DESCRIPTION

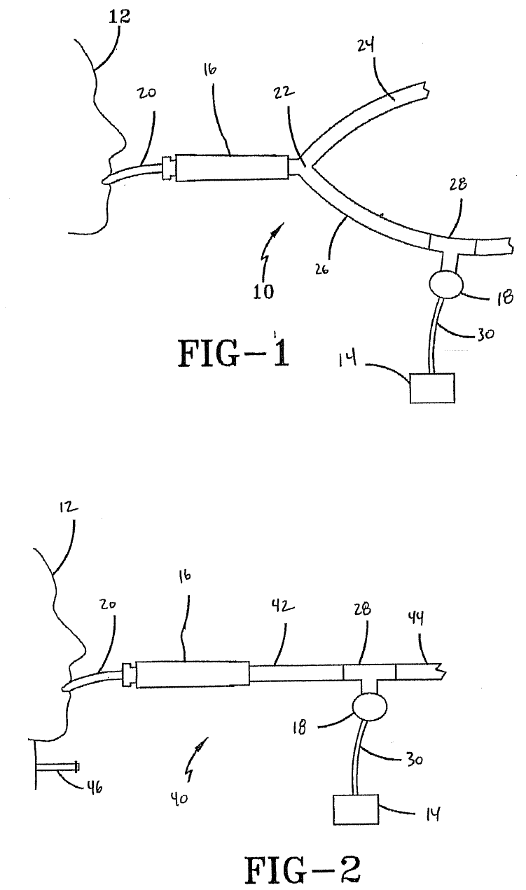

As described in detail below, aspects in accordance with principles of the present disclosure relate to an HME unit useful with a patient breathing circuit. As a point of reference, FIG. 1 illustrates one such breathing circuit 10 as including a number of flexible tubing segments that are connected in between a patient 12 and a ventilator (not shown). The breathing circuit 10 of FIG. 1 is a dual limb breathing circuit, and can include a source of pressurized air 14, an HME unit 16 (shown in block form) in accordance with the present disclosure, and a nebulizer 18.

With the one, non-limiting example of the breathing circuit 10 in mind, a patient tube 20 is provided that connects the patient 12 to the HME unit 16. An end of the patient tube 20 that interfaces with the patient 12 can be an endotracheal tube that extends through the patient's mouth and throat and into the patient's lungs. Alternatively, it also may be connected to a tracheostomy tube (not shown in FIG. 1, but referenced at 46 in FIG. 2) that provides air to the patient's throat and thereby to the patient's lungs. Extending on an opposite side of the HME unit 16 is a connector 22, for example a Y-connector. The Y-connector 22 can be connected to additional tubing for example, an exhalation tube 24 (commonly referred to as the “exhalation limb”) that allows exhaled air to leave the breathing circuit 10. A second tube 26 (commonly referred to as the “inhalation limb”) can serve as a nebulizer tube, and is connected to the nebulizer 18. The nebulizer 18, in turn, is connected to the inhalation limb 26 via a connector 28, for example a T-connector. The T-connector 28 is connected at an end opposite the inhalation limb 26 to a ventilator (not shown). The nebulizer 18, in turn, is also connected to the source of pressurized air 14 via an air tube 30.

By way of further reference, FIG. 2 illustrates an alternative breathing circuit 40 with which the HME unit 16 of the present disclosure is useful. The breathing circuit 40 is a single limb breathing circuit that again serves to fluidly connect a ventilator (not shown) with the patient 12, and includes the nebulizer 18 and the source of pressurized air 14. With the single limb breathing circuit 40, the patient tube 20 is again provided, fluidly connecting the patient 12 and the HME unit 16. A single tube 42 extends from the HME unit 16 opposite the patient 12, and is fluidly connected to the nebulizer 18 via the T-connector 28. The ventilator (not shown) is directly connected to the T-connector 28 via a tube 44. Where desired, the single limb breathing circuit 40 (as well as the dual limb breathing circuit 10 of FIG. 1) can be connected to a tracheostomy tube 46.

The present disclosure contemplates use of various types of nebulizers 18. With one example nebulizer 18, medication is provided that has been reconstituted with sterile water and placed in a reservoir provided in the nebulizer 18. Pressurized gas is provided to the nebulizer 18 that is blown across an atomizer within the nebulizer 18. The force of the gas over the atomizer pulls the medicated liquid from the medication reservoir up along the sides of the nebulizer 18 in a capillary action to provide a stream of the medicated liquid at the atomizer. When the medicated liquid hits the stream of forced air at the atomizer, the liquid is atomized into a multiplicity of small droplets. The force of the air propels this now nebulized mixture of air and medicated liquid into the breathing circuit 10, 40 and to the patient 12, where the medication is provided to the patient's lungs. Use of administration of medication in this procedure has been found to be highly effective in providing the medication through the lungs to the patient. Metered dose inhalers can also be used to provide medication in the air to the patient 12. In other embodiments, the HME unit 16 of the present disclosure is configured for use with a patient breathing circuit not otherwise including the nebulizer 18 or while the nebulizer 18 is not operating (e.g., the HME unit 16 is fluidly uncoupled from the breathing circuit during operation of the nebulizer 18).

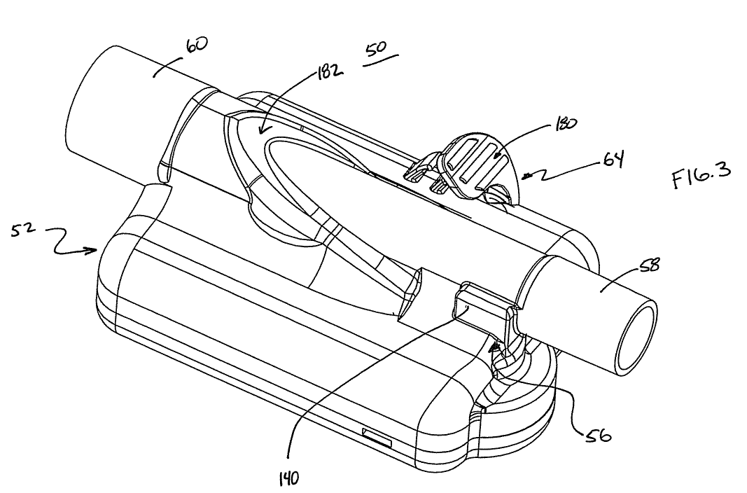

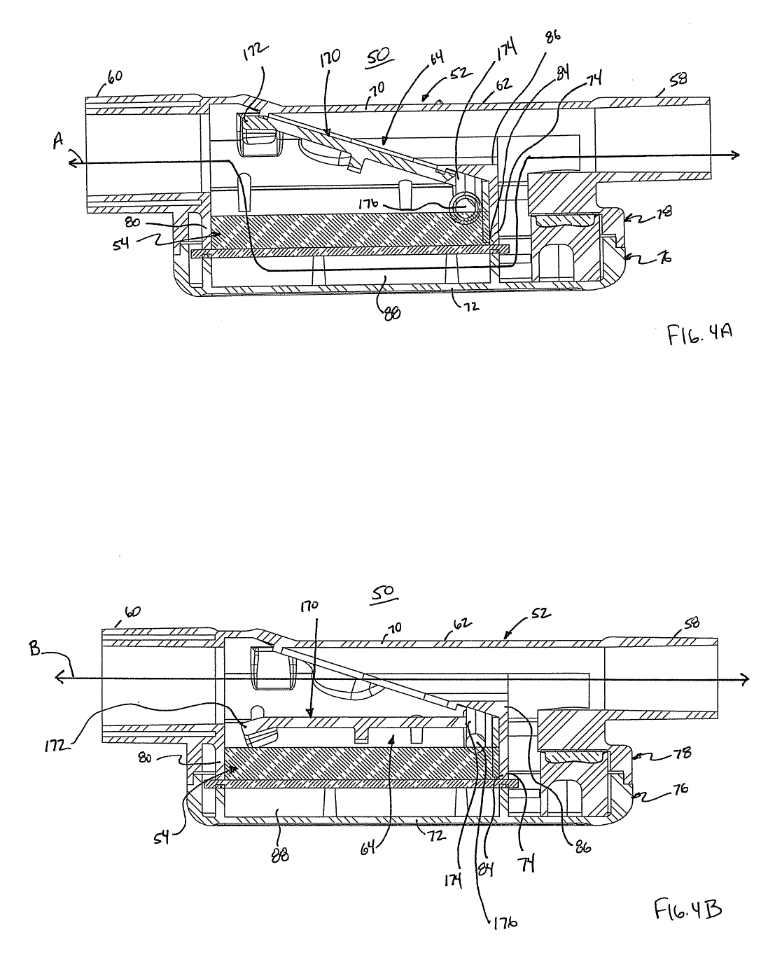

With the above general explanation of breathing circuits in mind, one configuration of an HME unit 50 useful as the HME unit 16 (FIGS. 1 and 2) is shown in FIG. 3. The HME unit 50 includes a housing 52, a heat and moisture media (HM media) 54 (hidden in FIG. 3, but shown in FIG. 4A), and a resistance indicator 56 (referenced generally in FIG. 3). Details on the various components are provided below. In general terms, however, the housing 52 forms a first port 58, a second port 60, and an intermediate section 62. The HM media 54 is retained within the intermediate section 62. The housing 52 generally defines one or more flow paths fluidly connecting the ports 58, 60, including a first flow path through the HM media 54, and optionally a second flow path around (e.g., to the side of) the HM media 54. In this regard, the resistance indicator 56 operates to provide a visual appearance indicative of pressure differential within (or across) the housing 52. With embodiments in which the HME unit 50 provides a flow path around the HM media 54, an optional valve mechanism 64 (referenced generally) can be included that is operable to dictate the flow path through which air flow will at least primarily occur.

The housing 52, including the optional flow paths formed thereby, is further illustrated in FIGS. 4A and 4B. As shown, the intermediate section 62 extends between the first and second ports 58, 60. Relative to the upright orientation of FIGS. 4A and 4B, the intermediate section 62 forms an upper exterior portion or wall 70, a lower exterior portion or wall 72, and at least one interior partition 74. With some configurations, the lower wall 72 is provided as part of a first housing segment 76 that is removably mounted to a second housing segment 78 that otherwise provides the ports 58, 60 and the upper wall 70. Regardless, the HM media 54 is retained within the intermediate section 62, for example nested between the interior partition 74 and a side wall 80. One or more other components can assist in maintaining the HM media 54 at a desired location relative to the interior partition 74 (and relative to the optional valve mechanism 64). Further, the interior partition 74 is a solid body defining, at least in part, a first flow path (designated in FIG. 4A by an arrow “A”) and a second flow path (designated in FIG. 4B by an arrow “B”). More particularly, the interior partition 74 forms opposing first and second ends 84, 86, with the first flow path A being formed, in part, between the first end 84 and the lower wall 72, and the second flow path B being formed, in part, between the second end 86 and the upper wall 70.

The first flow path A progresses from the first port 58, through the HM media 54, and to the second port 60 (and vice-versa), and thus can be referred to as an HME pathway. With the one configuration of FIG. 4A, the HM media 54 is sized and positioned within the housing 52 such that a gap 88 is formed between the HM media 54 and the lower wall 72, with the first flow path A traversing through the gap 88 and around the first end 84 of the interior partition 74 to establish a U-shaped pathway. With other configurations, however, the HM media 54 can be in contact with the lower wall 72 (or the gap 88 otherwise eliminated).

The second flow path B progresses from the first port 58, through the intermediate section 62, and to the second port 60 (and vice-versa), and does not include the HM media 54. Thus, the second flow path B can be referred to as a bypass pathway. The bypass pathway B is around, or to the side of, the HM media 54. In other embodiments, the HME unit 50 can be configured such that the bypass pathway B is through one or more apertures formed in the HM media 54. As described in greater detail below, the valve mechanism 64 is operable to selectively open and close (or at least partially close) the flow paths A, B.

As indicated above, the HM media 54 is sized and shaped for placement within the intermediate section 62. In this regard, the HM media 54 can assume a variety of forms known in the art that provide heat and moisture retention characteristics, and typically is or includes a foam material. Other configurations are also acceptable, such as paper or filter-type bodies. In more general terms, then, the HM media 54 can be any material capable of retaining heat and moisture regardless of whether such material is employed for other functions (e.g., filtering particle(s)).

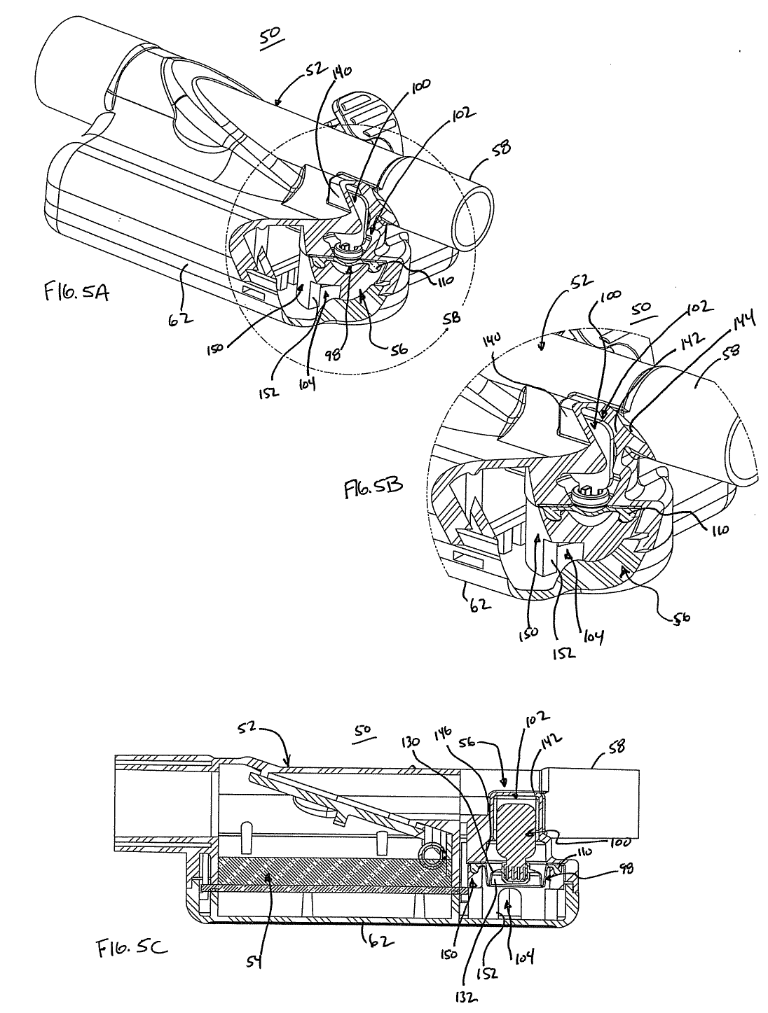

With the above general understanding of the HME unit 50 in mind, the resistance indicator 56 is shown in greater detail in FIGS. 5A-5C. The resistance indicator 56 is carried by the housing 52, in fluid communication with the first port 58. In general terms, the resistance indicator 56 is configured to generate a visually perceptible indicator based upon a pressure and/or pressure differential within the housing 52. For example, in some embodiments, the resistance indicator 56 transitions from a first state to a second state when a pressure differential within the housing 52 exceeds a pre-determined value for a pre-determined time period. As described below, the component(s) of the resistance indicator 56 are more readily visually perceived by a caregiver from an exterior of the housing 52 in the second state as compared to the first state.

In some embodiments, the resistance indicator 56 includes a deflectable membrane or diaphragm 98, a flag 100, a first (e.g., upper) chamber 102, and a second (e.g., lower) chamber 104. The membrane 98 maintains the flag 100 is assembled between the chambers 102, 104. At least one of the chambers 102, 104 establishes a fluid connection of air flow/pressure in the intermediate section 62 with the membrane 98. In some embodiments, both of the chambers 102, 104 provide fluid connection to air flow/pressure with opposite sides, respectively, of the membrane 98. Thus, the membrane 98 is “exposed” to a pressure differential within the housing 52, and in particular the pressure differential being experienced at the first port 58. As described below, a position of portions of the membrane 98, and thus of the flag 100, relative to the chambers 102, 104 changes in response to this pressure or pressure differential.

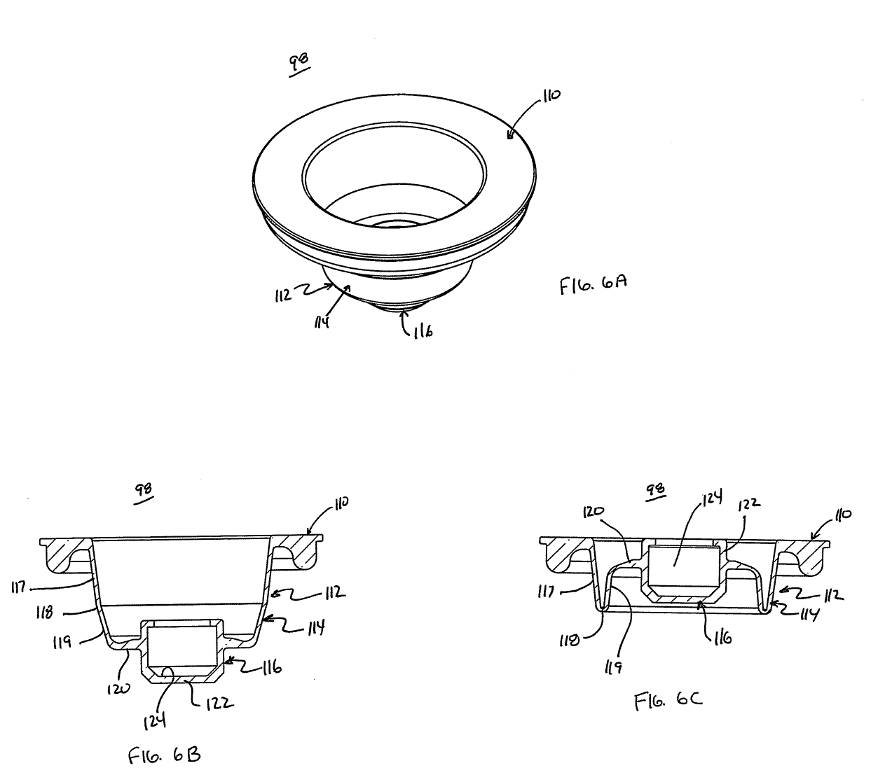

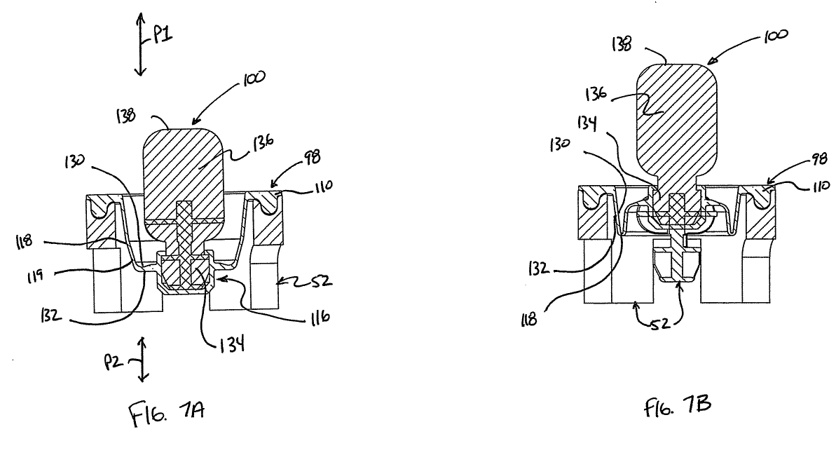

The membrane 98 is, in some embodiments, formed of a silicone material, although other elastomeric materials (e.g., polyurethane) can also be employed. With this in mind, and with reference to FIGS. 6A-6C, the membrane 98 defines, in some embodiments, a rim 110 and a central section 112. The rim 110 is sized and shaped for assembly between the chambers 102, 104 (FIG. 5C) as described below, and can be circular, square, etc. The central section 112 includes an annual wall 114 and a button segment 116. As best shown in FIG. 6B, the annual wall 114 extends from the rim 110 and forms a leading portion 117, a deflection region 118, and a trailing portion 119. The deflection region 118 is defined, for example, by a circumferential region of increased diameter and/or increased wall thickness as compared to the trailing portion 119. As described below, a longitudinal position of the button segment 116 relative to the rim 110 is dictated by the annular wall 114, with the annular wall 114 deflecting or flexing at the deflection region 118 (i.e., the annular wall 114, and thus the button segment 116, is deflectable from the first state of FIG. 6B to a second state of FIG. 6C). More particularly, the trailing portion 119 of the annular wall 114 extends from the deflection region 118 in a conical or tapering diameter fashion such that the trailing portion 119 is inherently amenable to deflection/flexation at the deflection region 118.

The button segment 116 includes a shoulder 120 and a head 122. The shoulder 120 extends radially inwardly from the trailing portion 119 (opposite the deflection region 118), with the head 122 centrally disposed relative to the shoulder 120 and forming a receptacle 124 sized to retain the flag 100 (FIG. 5A) as described below.

While the membrane 98 is, in some embodiments, homogeneously formed, wall thicknesses at various points are varied so as to establish inherent deflection characteristics whereby the membrane 98 deflects, and remains in a deflected position, along the annular wall 114 in response to a pre-determined force level as described below. For example, in some embodiments, a wall of thickness the button segment 116, and in particular of at least the shoulder 120, is greater than that of the annular wall 114 (it being recalled, however, that the deflection region 118 can have a wall thickness greater than that of a remainder of the wall 114) to direct deflection of the membrane 98 to occur at the annular wall 114. Further, the wall thickness(es) of the head 122 establish a mass of the button segment 116, and thus (in combination with the flag 100) a force required to “lift” the button segment 116 from the first state (FIG. 6B) to the second state (FIG. 6C). Finally, the tapered diameter configuration of the trailing portion 119 relative to the larger diameter and wall thickness of the deflection region 118 permits deflection/flexation of the trailing portion 119 to the second state (FIG. 6C). In the second state, however, the deflection region 118 forms a tight bend whereby the trailing portion 119 is “within” the leading portion 117. This arrangement overtly resists deflection of the annular wall 114 from the second state (FIG. 6C) back to the first state (FIG. 6B) (i.e., the membrane 98 will not self-transition from the second state to the first state).

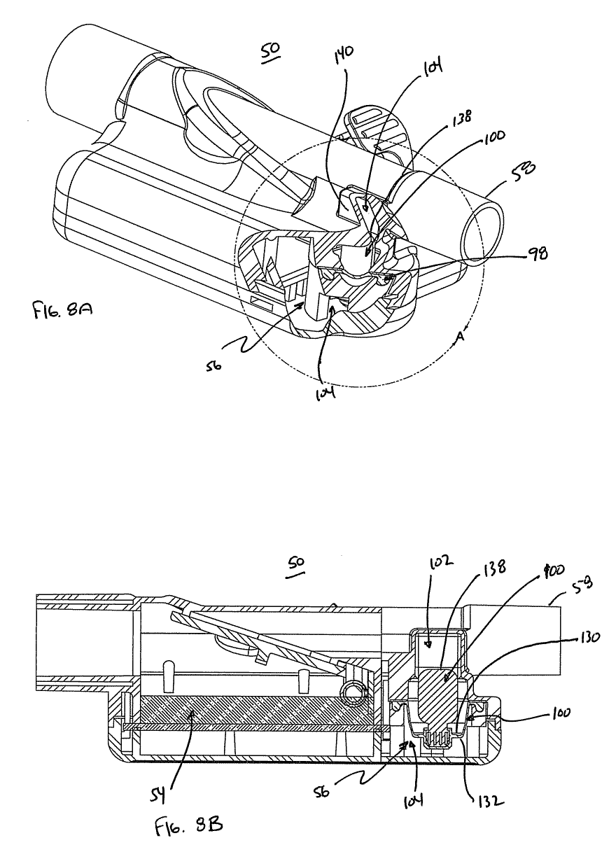

With reference to FIGS. 7A and 7B, the rim 110 and the central section 112 combine to define opposing, first and second faces 130, 132 of the membrane 98. As a point of reference, FIGS. 7A and 7B further illustrate the flag 100 along with portions of the housing 52. With this in mind, the flag 100 extends from the first face 130 and includes a base 134 and a panel 136. The panel 136 terminates in a leading end 138 opposite the base 134. In some embodiments, the flag 100 is integrally formed of a relatively stiff material (e.g., thermoplastic resin) that has a visually perceptible or distinct coloring (e.g., orange, red, black, fluorescent, etc.). Regardless, the base 134 is sized to be captured within the receptacle 124, with the panel 136 thus projecting away from the button segment 116.

The membrane 98/flag 100 can be assembled to the housing 52 (FIG. 5A) such that the first face 130 is exposed to a first pressure or force (arrow “P1” in FIG. 7A) and the second face 132 is fluidly exposed to a second pressure or force (“P2” in FIG. 7A). These pressures P1, P2 thus create a pressure differential across the membrane 98. When the second pressure P2 exceeds the first pressure P1 by a certain amount, the membrane 98 transitions from the first state or position of FIG. 7A to the second state or position shown in FIG. 7B. In the first state, the leading end 138 of the flag 100 is slightly spaced from a plane defined by the rim 110. When a force or pressure differential applied to the second face 132 is sufficient to overcome a mass of the flag 100 and the button segment 116, as well as an inherent, slight resistance to deflection by the trailing portion 119 of the annular wall 114, the annular wall 114 deflects to the deflection region 118, with the button segment 116 transitioning upwardly (relative to the orientations of FIGS. 7A and 7B). In the position of FIG. 7B, the leading end 138 of the flag 100 is discretely spaced from the plane defined by the rim 110. In other words, a longitudinal spacing between the leading end 138 and the rim 110 is greater in the position of FIG. 7B as compared to the position of FIG. 7A. In some embodiments, the membrane 98 is configured to transition from the first state of FIG. 7A to the second state of FIG. 7B in the presence of a pressure differential in excess of 5 cm water (e.g., P2 is greater than P1 by at least 5 cm water) for more than 0.5 second. At lesser pressure differentials (e.g., P2 slightly greater than P1), the trailing portion 114 may slightly deflect upwardly (and downwardly) but the membrane 98 does not “self-hold” this deflected orientation. Alternatively, a wide variety of other transition-causing parameters can be incorporated into a design of the membrane 98 and/or the flag 100.

Returning to FIGS. 5A-5C (that otherwise illustrate the membrane 98 in the second or “triggered” state described above), the first chamber 102 is sized for assembly to the membrane 98 and is formed, at least in part, by an exterior wall portion 140 (best shown in FIG. 5A) of the housing 52. The first chamber 102 is sized to slidably receive the flag 100 in the second state of the membrane 98 (as otherwise reflected in the views of FIGS. 5A-5C). That is to say, the wall(s) defining the first chamber 102 are sufficiently spaced so as to not impede transitioning of the flag 100 from the first state to the second state.

In some embodiments, the exterior wall portion 140 is configured to be sufficiently transparent so as to permit viewing of the flag 100 external the HML unit 50. For example, with some manufacturing techniques in accordance with the present disclosure, the housing 52 is formed of a plastic material. During manufacture, the exterior wall portion 140 otherwise forming a segment of the first chamber 102 is highly polished or otherwise processed to render the exterior wall portion 140 nearly transparent (as compared to other exterior regions of the housing 52 that can have a more clouded or fogged characteristic). Stated otherwise, the exterior wall portion 140 forms a window.

In addition to the exterior wall portion 140, the first chamber 102 is defined by one or more interior walls 142. The interior wall(s) 142 forms a first passage 144 (FIG. 5B) through which air flow/pressure at the first port 58 enters the first chamber 102. An optional second passage 146 (referenced generally in FIG. 5C) is further formed, providing an exit path from the first chamber 102 (e.g., to the second flow path B (FIG. 4B)). Regardless, air flow/pressure being experienced at the first port 58 is transferred to the first chamber 102 via the passage 144 and imparted upon the membrane 98 as described below.

The second chamber 104 is formed by a platform 150 sized to receive the rim 110 of the membrane 98. Thus, the platform 150 has a size and shape commensurate with that of the rim 110, and can be circular, square, etc. Regardless, the platform 150 forms one or more of the channels 152 opposite the membrane 98 and fluidly open to air flow/pressure within the housing 52, adjacent the HM media 54 (along the first flow path A (FIG. 4A)). Thus, air flow/pressure along the first flow path A is transferred to the second chamber 104 via the channel 152 and imparted upon the membrane 98.

The membrane rim 110 is assembled between the walls 140, 142 of the first chamber 102 and the platform 150 of the second chamber 104 so as to seal the chambers 102, 104 from one another (relative to the membrane 98). The flag 100 is slidably disposed within the first chamber 102. Air flow/pressure at the first chamber 102 (via the passage 144) acts upon the first face 130 of the membrane 98, whereas air flow/pressure at the second chamber 104 (via the channel 152) acts upon the second face 132. With this construction, then, a pressure differential across the membrane 98 (via the chambers 102, 104) is representative of a pressure differential across the HME unit 50, and in particular at the first port 58 in that air flow pressure “entering” at the first port 58 is delivered into the first chamber 102, with any corresponding increase in pressure (or back pressure) due to the presence of the HM media 54 being delivered into the second chamber 104. Effectively, then, any flow/pressure resistance attributable to the HM media 54 is placed upon the resistance indicator 56, with the membrane 98 changing states when the so-attributable resistance exceeds a certain level.

In particular, and with reference to FIGS. 8A and 8B, the membrane 98/flag 100 is initially assembled to the chambers 102, 104 in the first or “lowered” state. While the membrane 98/flag 100 may be somewhat visually perceptible to a user or caregiver via the exterior wall portion/window 140 in the first or lowered state, the leading end 138 is outside of the window 140 (e.g., “below” the window 140), and thus is not overtly seen through the window 140. When the HME unit 50 is provided to a caregiver with the membrane 98/flag 100 in the first or lowered state, the caregiver will inherently recognize the “absence” of the colored flag 100 within the window 140 as being indicative of acceptable pressure differential within the HME unit 50.

During use, the HME unit 50 is fluidly connected to a patient breathing circuit, for example the breathing circuit 10 of FIG. 1 or the breathing circuit 40 of FIG. 2. The patient tube 20 is fluidly connected to the second port 60, and the first port 58 is fluidly connected to tubing connected to the ventilator (not shown). Thus, the first port 58 serves as a ventilator-side port, and the second port 60 serves as a patient-side port. Air flow/pressure from the ventilator is transmitted to the patient via the HME unit 50. In conjunction with this air flow/pressure, the resistance indicator 56 functions to alert a caregiver of a potentially problematic functioning of the HME unit 50. For example, when a pressure differential within the housing 52, as otherwise being experienced at the ventilator-side port 58, exceeds a pre-determined value for a pre-determined time period, the resultant differential force being exerted upon the second face 132 of the membrane 98 (as compared to the baseline pressure/force at the first face 130) causes the button segment 116, and thus the flag 100, to move upwardly, with deflection occurring at the deflection region 118.

In particular, the membrane 98/flag 100 transitions from the initial state of FIG. 8A to the second or triggered state shown in FIG. 5A, with the panel 136 now being positioned within the first chamber 102 at the window 140. Once in the second state, the membrane 98 does not revert back toward the first state even as the pressure differential applied to the membrane 98 decreases. Due to the distinct color of the flag 100 along with the highly transparent nature of the window 140, the caregiver will readily recognize that the resistance indicator 56 is visually indicating existence of a potentially problematic pressure differential condition within the HME unit 50. Under these circumstances, then, the caregiver can make appropriate conclusions (e.g., that the HM media 54 is clogged) and take appropriate actions. Further, where the caregiver believes that the breathing circuit 10, 40 is experiencing undesirable resistance to air flow/pressure yet notices that the resistance indicator 56 is not indicating excessive pressure differential conditions within the HME unit 50 (i.e., the flag 100 has not transitioned to the second or triggered state of FIG. 5A), the caregiver will quickly understand that the HME unit 50 is not the cause of the air flow/pressure resistance concerns, and can instead focus on other components of the breathing circuit 10, 40.

Returning to FIGS. 3-4B, with some non-limiting embodiments in which the HME unit includes the valve mechanism 64, the valve mechanism 64 dictates which of the flow paths A or B air flow between the ports 58, 60 will at least primarily occur. In this regard, the valve mechanism 64 includes an air flow obstruction member 170 that is movably disposed or assembled within the intermediate section 62 as best shown in FIGS. 4A and 4B. The obstruction member 170 can assume a variety of shapes, and is generally provided as a solid body or bodies through which air flow cannot pass. In the one configuration of FIGS. 4A and 4B, the obstruction member 170 is plate-like; alternatively, other valving obstruction bodies (e.g., ball valve, etc.) are also acceptable. Regardless, the obstruction member 170 is transitionable between a first position shown in FIG. 4A and a second position shown in FIG. 4B. For example, with the one configuration of FIGS. 4A and 4B, the obstruction member 170 is akin to a plate, defined by a leading end 172 and a trailing end 174. The trailing end 174 is pivotably mounted within the housing 52, for example, via a pin 176. Other transitionable assembly constructions are also acceptable, such as by providing the trailing end 174 as a living hinge. With these constructions, then, transitioning of the obstruction member 170 includes the obstruction member 170 pivoting at the trailing end 174, with the leading end 172 traveling between the first and second positions. With this in mind, the leading end 172 is configured to engage or seal against a corresponding structure of the housing 52, for example, the upper wall 70, in the first position of FIG. 4A. In other words, the obstruction member 170 is sized and shaped such that in the first position, the obstruction member 170 closes the second flow path B, thereby forcing or dictating that all air flow occur along the first flow path A. Because the first flow path A includes the HM media 54, the first position of the obstruction member 170 can be referred to as an “HME position” or “HME mode”.

With specific reference to FIG. 4B, in the second position of the obstruction member 170, the leading end 172 is transitioned (e.g., pivoted at the trailing end 174) away from engagement with the upper wall 70, such that the second flow path B is not obstructed by the obstruction member 170. Notably, in the second position, the obstruction member 170 does not completely obstruct or close the first flow path A in accordance with some embodiments. For example, a spacing 178 exists between the leading end 172 of the obstruction member 170 and the corresponding side wall 80 of the housing 52.

In the second position of the obstruction member 170, the second flow path B is at most only partially obstructed by the obstruction member 170, thereby allowing air flow to freely progress to and from the first and second ports 58, 60 without intimately encountering the HM media 54. Thus, the second position of the obstruction member 170 can be referred to as a “bypass position” or “bypass mode”. In the bypass position, gas flow can still occur along the first flow path A via the spacing 178 in some embodiments. However, the HM media 54 effectively serves to restrict or resist gas flow through the spacing 178. In particular, because gas flow will seek the path of least resistance, in the bypass position of the obstruction member 170, a vast majority of the gas flow will occur directly through or along the second flow path B. In fact, it has surprisingly been found that at least 95% of gas flow will occur through the second flow path B with the obstruction member 170 in the bypass position. In other embodiments, the valve mechanism 64 is configured to close the HME flow path A in the bypass mode.

The valve mechanism 64 can include various components for effectuating user-actuated movement of the obstruction member 170 between the HME position and the bypass position. For example, an actuator arm 180 (FIG. 3) can be provided that is connected to the obstruction member 170 and extends from an exterior of the housing 52. User movement of the actuator arm 180 effectuates pivoting movement of the obstruction member 170 to a desired position. Further, in some embodiments, an optional locking mechanism 182 can be provided that selectively locks and releases the actuator arm 180 as desired. Alternatively, the valve mechanism 64 can assume a wide variety of other forms. Even further, where the HME unit 50 does not provide a separate, bypass flow path, the valve mechanism 64 can be eliminated.

With embodiments in which the HME unit 50 provides the HME flow path and bypass flow path, as well as the valve mechanism 64 described above, use of the HME unit 50 in conjunction with the patient breathing circuit 10, 40 (FIGS. 1 and 2) can further include the caregiver selecting a desired mode of operation. In instances where medication is not being provided to the patient 12 via the breathing circuit 10, 40 (i.e., the nebulizer 18 is either not connected to the breathing circuit 10, 40 and/or is non-operational), the HME unit 50 is operated in the HME mode (FIG. 4A). Thus, gas flow to and from the patient 12 via the HME unit 50 must pass through the HM media 54 (as well as an optional secondary filter 190 where provided), with the HM media 54 absorbing moisture and heat from exhaled air, and then transferring moisture and heat to the inhaled air provided to the patient's lungs.

In instances where the nebulizer 18 is operated to administer nebulized medication to the patient 12, the HME unit 50 is readily transitioned from the HME mode to the bypass mode (FIG. 4B) by a user pressing on the actuator arm 180. With the obstruction member 170 in the bypass position, gas flow to and from the patient 12, via the HME unit 50, occurs primarily along the bypass flow path B (due to the resistance created by the HM media 54), and thus around (e.g., to the side of) the HM media 54. In the bypass mode, then, the possibility of the HM media 54 becoming clogged with medication droplets is virtually eliminated.

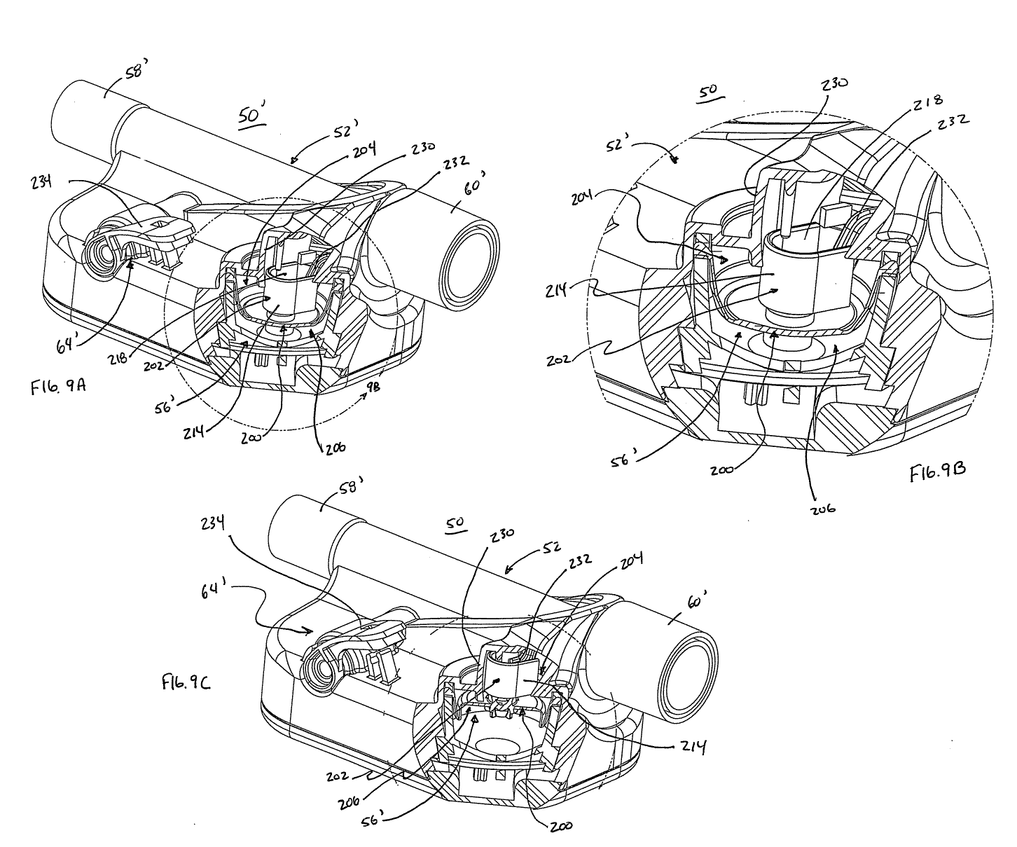

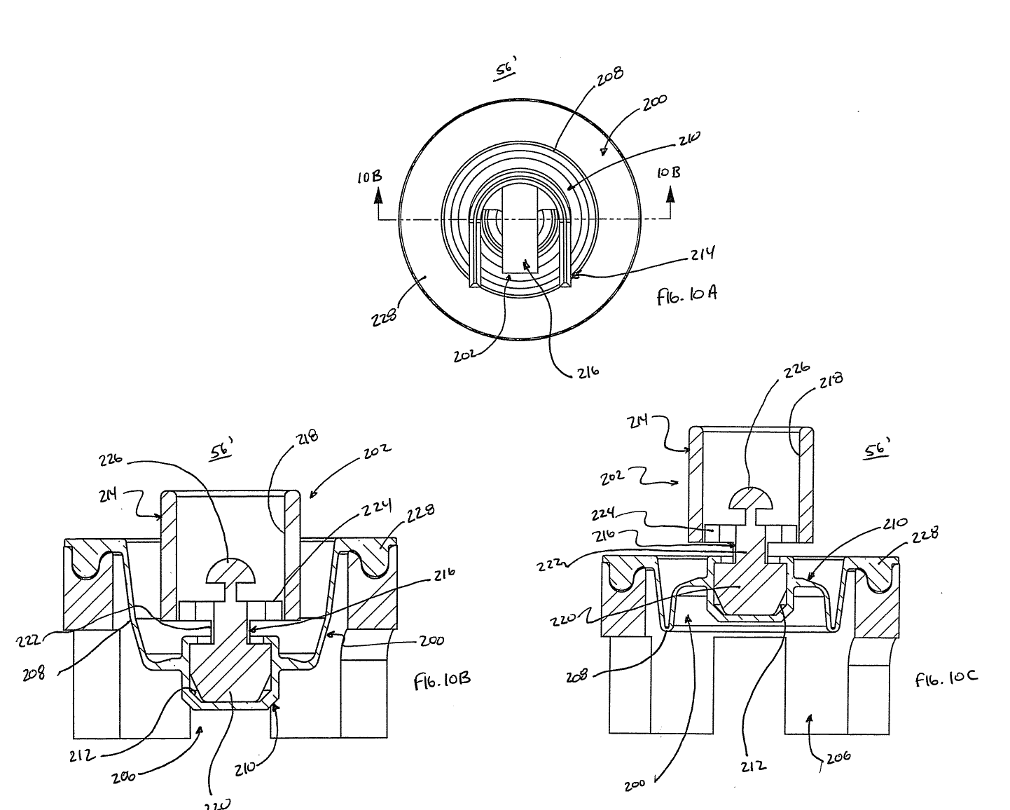

The resistance indicator 56 described above is but one acceptable configuration in accordance with principles of the present disclosure. For example, the resistance indicator 56 can be configured to generate a visually perceptible indication of an excessive pressure differential in an opposite direction to that described above, (i.e., where P1>>P2). An alternative embodiment HME unit 50′ is shown in FIGS. 9A and 9B, and incorporates an alternative resistance indicator 56′. The HME unit 50′ is, many respects, similar to the HME unit 50 (FIG. 3) described above, and includes a housing 52′ maintaining an HM media (not shown, but akin to the HM media 54 described above) between first and second ports 58′, 60′. Further, a valve mechanism 64′ operates to dictate a flow path through which airflow between the ports 58′, 60′ will primarily occur. With this in mind, the resistance indicator 56′ includes a membrane 200, and a flag assembly 202. The membrane 200 maintains the flag assembly 202 between first and second chambers 204, 206, and facilitates transitioning of the flag assembly 202 between an initial state of FIG. 9A and a triggered state of FIG. 9C when subjected to a pressure differential (i.e., P2>P1) as described above.

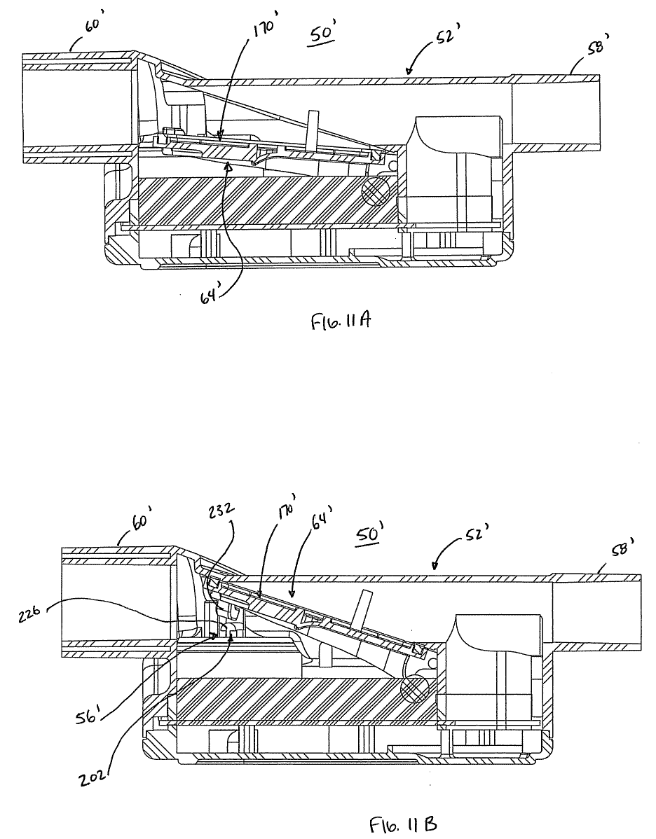

The resistance indicator 56′ is shown in greater detail in FIGS. 10A and 10B, with FIG. 10B illustrating the membrane 200 assembled to the second chamber 206. As shown, the membrane 200 is highly similar to the membrane 98 (FIGS. 6A-6C), and includes or defines a deflection region 208, and a button segment 210 forming a receptacle 212. The flag assembly 202 includes a flag 214 and a connector body 216. The flag 214 is formed of a relatively stiff material (e.g., thermoplastic resin) that has a visually perceptible or distinct coloring (e.g., orange, red, black, fluorescent, etc.). The flag 214 is U-shaped (reflected in FIGS. 9A and 10A), defining an aperture 218 as best shown in FIG. 10B.

The connector body 216 includes a base 220, a neck 222, a flange 224, and a prong 226. The base 220 sized to be captured within the receptacle 212, with the neck 222 thus projecting away from the button segment 210. The flange 224 extends radially outwardly from the neck 222, and is sized for assembly (e.g., weld, adhesive, etc.) to the flag 214. Alternatively, the flag 214 and the connector body 216 can be a homogenous, integrally formed structure. Regardless, the prong 226 projects upwardly (relative to the orientation of FIG. 10B) from the neck 222. Upon final assembly, then, the prong 226 extends within the aperture 218.

With the above construction, the resistance indicator 56′ is transitionable from the initial state of FIG. 10B to the trigger state of FIG. 10C. As reflected by comparison of FIGS. 10B and 10C, in the initial state (FIG. 10B), a majority of the flag 214 is “below” a rim 228 of the membrane 200. Conversely, in the trigger state of FIG. 10C, a majority, and in some embodiments an entirety, of the flag 214 is “above” the rim 228, with the membrane 200 deflecting at the deflection region 208 as described above.

Returning to FIGS. 9A and 9C, the above-described resistance indicator 56′ is assembled within the housing 52′ and operates similar to previous embodiments. In this regard, the housing 52′ can form a window portion 230 (referenced generally in FIGS. 9A and 9C) through which the flag 214 is visible or visually perceptible from an exterior of the HME unit 50′. Thus, in the presence of an excessive pressure differential across the chambers 204, 206 (i.e., a pressure within the second chamber 206 exceeds a pressure within the first chamber 204 by a predetermined level), the resistance indicator 56′ will transition from the initial state of FIG. 9A to the triggered state of FIG. 9C.

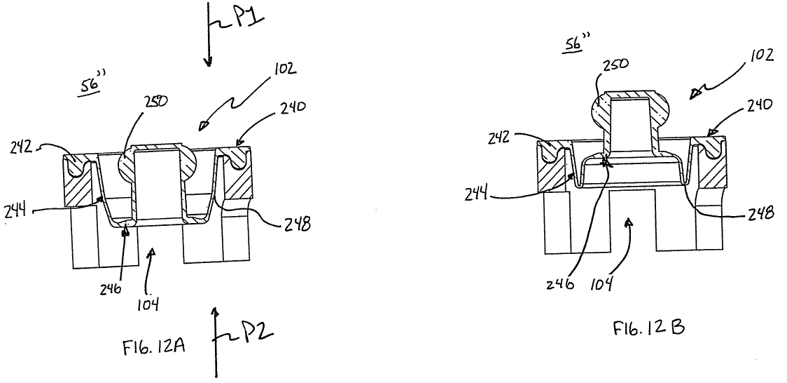

In some embodiments, HME units in accordance with the present disclosure are configured to allow a user to manually “re-set” the resistance indicator from the triggered state back to the initial state. For example, the HME unit 50′ can include a valve mechanism 64′ that is akin to the valve mechanism 64 (FIG. 3) previously described, and includes an obstruction member 170′ that is movably disposed or assembled within the housing 52′ as best shown in FIGS. 11A and 11B. Further, a tab 232 is formed by or extends from the obstruction member 170′. As a point of reference, the tab 232 is partially visible in the views of FIGS. 9A, 9C, and 11B. With specific reference to FIGS. 9A and 9C, the tab 232 is sized to be received within the aperture 218 of the flag 214. Further, and as best reflected in FIG. 11B, the tab 232 is positioned to selectively interface with the prong 226 of the flag assembly 202. During use, and with the obstruction member 170′ in an HME mode or state (i.e., the position of FIG. 11B), the resistance indicator 56′ operates as previously described, transitioning from the initial state (FIG. 9A) to the triggered state (FIG. 9C) in the presence of an excessive pressure differential. In the triggered state of the resistance indicator 56′, the prong 226 is raised into close proximity with the tab 232 as shown in FIG. 11B.

The resistance indicator 56′ can then be “re-set” by transitioning the obstruction member 170′ from the HME position of FIG. 11B to the bypass mode or state of FIG. 11A. For example, the valve mechanism 64′ can include an actuator arm 234 (FIGS. 9A and 9C) connected to the obstruction member 170′. Rotation of the actuator arm 234 by a user from the orientation of FIG. 9C to that of FIG. 9A transitions or rotates the obstruction member 170′ from the HME mode (FIG. 11B) to the bypass mode (FIG. 11A). With this movement, the tab 232 contacts the prong 226, and subsequently forces or directs the resistance indicator 56′ from the triggered state to the initial state (i.e., from the position of FIG. 9C to the position FIG. 9A). To provide HME therapy, the obstruction member 170′ is subsequently transitioned back to the HME mode or state of FIG. 11B. Notably, however, the resistance indicator 56′ remains in the initial state (i.e., the resistance indicator 56′ does not self-transition to the triggered state with movement of the obstruction member 170′/tab 232). Instead, the resistance indicator 56′ functions as previously described, transitioning to the triggered state only in the presence of an excessive pressure differential.

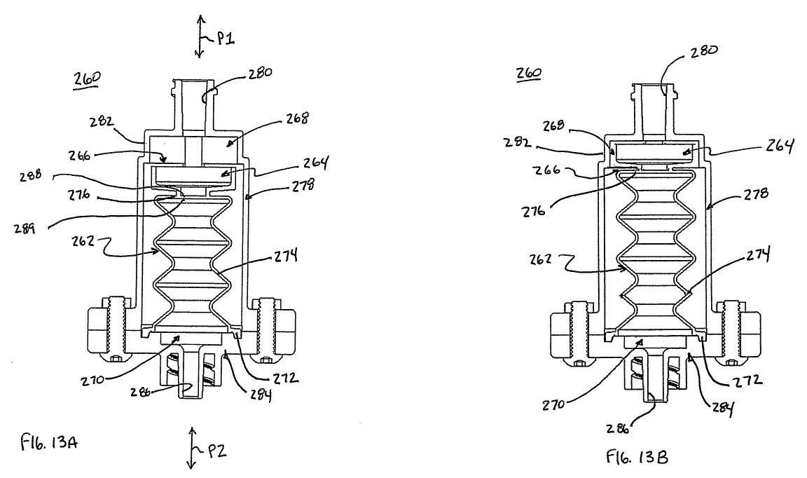

In yet other embodiments, the flag 100 (FIG. 7A), 214 can be eliminated. For example, a portion of an alternative resistance indicator 56″ is shown in FIGS. 12A and 12B, and includes a membrane 240, and the chambers 102, 104 (referenced generally) previously described. The membrane 240 is akin to the membrane 98 (FIGS. 6A-6C) described above, and includes a rim 242, an annular wall 244, and a button segment 246. The annular wall 244 forms a deflection region 248, with the button segment 246 including a head 250 extending upwardly from the annular wall 244 opposite the rim 242.

The membrane 240 has a visually perceptible, bright color and is constructed to transition from an initial state (FIG. 12A) to a trigger state (FIG. 12B) when subjected to a pressure differential (i.e., P2>P1) as described above. In the initial state, the head 250 is substantially “below” the rim 242. Thus, where the rim 242 is sealed between the chambers 102, 104, the head 250 is “outside” of the first chamber 102 and will not be readily visually perceived by a caregiver. Conversely, in the triggered state, the head 250 is displaced to be substantially “above” the rim 242, and “in” the first chamber 102. Thus, a caregiver will readily visually perceive the head 250 (e.g., via the window 140 (FIG. 5A) described above). As with some previous embodiments, the membrane 240 is configured to retain the triggered state or position even after the pressure differential condition causing the membrane 240 to transition to the triggered state has subsided.

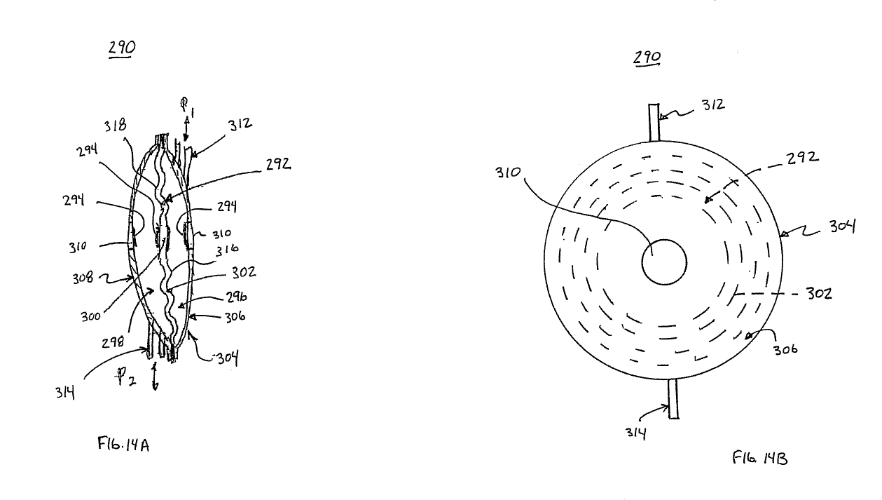

Another embodiment resistance indicator 260 useful with HME units in accordance with the present disclosure is partially illustrated in FIGS. 13A and 13B. In general terms, the resistance indicator 260 includes a membrane or diaphragm 262, a disc 264, a latch 266, a first chamber 268, and a second chamber 270. The membrane 262 has a bellows-like configuration, and is sealed between the chambers 268, 270 in a manner akin to that previously described with respect to the resistance indicator 56 (FIG. 5A). The membrane 262 defines a rim 272, a bellows segment 274 extending from the rim 272, and differential segment 276 extending opposite the rim 272. With this construction, the differential segment 276 moves longitudinally within the first chamber 268 via expansion and contraction of the bellows segment 274 in response to forces acting upon the differential segment 276 as described below.

The disc 264 is secured to the differential segment 276, and thus transitions relative to the chamber 268 with movement of the membrane 262. In this regard, an outer diameter or other outer dimension of the disc 264 is greater than a corresponding diameter defined by the latch 266 such that when the membrane 262 moves the disc 264 from the position of FIG. 13A to the position of FIG. 13B, the disc 264 comes into contact with, and is captured by, the latch 266. This captured relationship prevents the disc 264/membrane 262 from moving downwardly from the position of FIG. 13B. The disc 264 can be made from a variety of relatively rigid materials (e.g., polypropylene, polycarbonate, etc.), and has a bright color (e.g., red, orange, etc.) in some embodiments so as to be more visually perceptible.

The first chamber 268 can be formed in a variety of fashions commensurate with a size/shape of the membrane 262, and generally includes a wall 278 forming at least one passage 280 establishing fluid communication between the first chamber 268 and air flow/pressure of interest as described above (e.g., the first port 58 of FIG. 5A). The latch 266 is formed as a radially-inward extension from first chamber wall 278 in some embodiments, although other constructions of the latch 266 (e.g., spring-loaded or other releasable configuration) are equally acceptable. Further, a portion of the wall 278 adjacent the latch 266 forms a window 282, for example by incorporating transparent and/or highly polished plastic as described above. Thus, in the triggered state of FIG. 13B, the disc 264 is visually perceptible by a user via the window 282.

The second chamber 270 can similarly assume a variety of forms appropriate for fluid communication with the membrane 262. For example, the second chamber 270 can be defined by a platform 284 forming one or more channels 286 establishing fluid communication between the second chamber 270 and air flow/pressure of interest as described above (e.g., adjacent the HM media 54 of FIG. 5C).

Upon final assembly, the membrane 262 is sealed between the chambers 264, 266 such that a first face 288 of the membrane 262/differential segment 276 is acted upon (via the disc 264) by pressure in the first chamber 268 (“P1” in FIG. 13A), and a second face 289 of the membrane 262/differential segment 276 is acted upon by pressure in the second chamber 270 (“P2” in FIG. 13A). As a pressure differential across the membrane 262 increases (i.e., P2>P1), the differential segment 276/disc 264 moves upwardly (relative to the orientations of FIGS. 13A and 13B); conversely, as the pressure differential decreases (i.e., P1>P2), the differential segment 276/disc 264 moves downwardly.

During use, the HME unit (not shown) to which the resistance indicator 260 is assembled functions as described above, with the HME unit transferring air flow/pressure to and from the patient. In this regard, under normal conditions, the membrane 262 cycles up and down in response to changes in the differential pressure between the first chamber 268 and the second chamber 270 (i.e., differential pressure between P1 and P2). Under circumstances where an excessive differential pressure occurs (i.e., P2 exceeds P1 by a pre-determined value, optionally for a pre-determined time period), the membrane 262 will force the disc 264 beyond the latch 266, with the latch 266 in turn capturing the disc 264. The now-captured position of the disc 264 is visually perceived by the caregiver via the window 282, thereby alerting the caregiver as to a potentially problematic functional status of the HME unit. Conversely, where the disc 264 is not within the window 282, a caregiver will visually recognize the absence of the disc 264 and readily conclude proper functional status (relative to flow resistance) of the HME unit. As with previous embodiments, the “locked” position of FIG. 13B is a second or triggered state of the resistance indicator 260, whereas any position of the membrane 262/disc 264 away from the latch 266 constitutes an initial or first state.

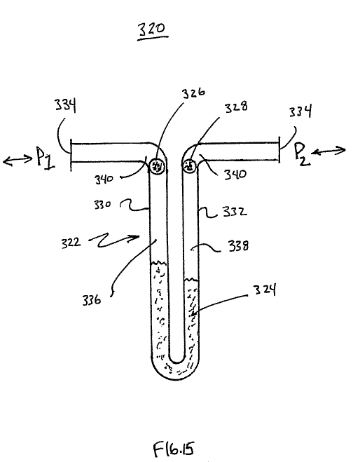

Another embodiment resistance indicator 290 in accordance with principles of the present disclosure is illustrated in FIGS. 14A and 14B. The resistance indicator 290 includes a membrane or diaphragm 292, adhesive 294, a first chamber 296, and a second chamber 298. In general terms, the membrane 292 is sealed between the chambers 296, 298, and is deflectable as a function of differential pressure across the membrane 292. Under circumstances where the differential pressure is excessive, the membrane 292 is held in place via the adhesive 294, thereby providing a visual indicator of a potentially problematic condition.

The membrane 292 can assume any of the forms previously described (e.g., silicone, polyurethane, etc.), and is defined by a central region 300 and an outer region 302. As reflected in the figures, the outer region 302 is deflectable, and thus can assume a wave-like shape in the first or relaxed state of FIG. 14A. In some embodiments, at least the central region 300 is brightly colored.

The chambers 296, 298 are, in some embodiments, defined in part by a housing 304 having first and second segments 306, 308. The segments 306, 308 are generally identical, each having a convex, hemispherical-like shape as shown in FIG. 14A. The housing segments 306, 308 can be formed of a wide variety of materials, such as plastic. With some constructions, however, a window 310 is formed in one or both of the segments 306 and/or 308 at a middle area thereof (e.g., highly polished or translucent plastic) as described above. Further, the first segment 306 forms one or more passages 312 establishing fluid communication between the first chamber 296 and air flow/pressure of interest as described above (e.g., the first port 58 of FIG. 5C). The second housing segment 308 similarly forms one or more channels 314 establishing fluid communication between the second chamber 298 and air flow/pressure of interest as described above (e.g., adjacent the HM media 54 of FIG. 5A). The adhesive 294 can assume a wide variety of forms, and in some embodiments, is a medically safe adhesive, such as a pressure sensitive adhesive. The adhesive 294 is applied to one or more of the central region 300 of the membrane 292, an interior of the first housing segment 306 at the window 310, and/or the second housing segment 308 at an interior surface corresponding with the window 310. As described below, the so-applied adhesive 294 effectuates bonding of the central region 300 of the membrane 292 with the corresponding housing segment 306 or 308 upon contact therebetween.

Upon final assembly, the membrane 292 is sealed between the housing segments 306, 308, thereby establishing the first and second chambers 296, 298. In this regard, a first face 316 of the membrane 292 is acted upon by pressure in the first chamber 296 (“P1” in FIG. 14A), and a second face 318 of the membrane 292 is acted upon by pressure in the second chamber 298 (“P2” in FIG. 14A).

During use, the HME unit (not shown) to which the resistance indicator 290 is assembled functions as previously described, with the HME unit transferring air flow/pressure to and from the patient. Under normal conditions, the membrane 292 will deflect back-and-forth relative to the housing segments 306, 308, with a spacing established between the windows 310 selected to ensure that the central region 300 of the membrane 292 does not contact the segments 306, 308 under acceptable differential pressure conditions. This non-contacting position of the membrane 292 constitute a first state of the resistance indicator 290. Under circumstances where an excessive differential pressure condition occurs (e.g., a pressure differential in excess of the pre-determined value, optionally for a pre-determined time period), the membrane 292 will overtly deflect, with the central region 300 contacting the window 310 of one of the housing segments 306 or 308. For example, where P2 greatly exceeds P1, the membrane 292 will deflect to a point at which the central region 300 contacts the first housing segment 306. The adhesive 294, in turn, holds the membrane 292 against the corresponding housing segment 306 or 308, thereby establishing a second or triggered state of the resistance indicator 290. Due to the translucent nature of the corresponding window 310, this bonded or adhered relationship will be visually perceived by a caregiver, thereby alerting the caregiver as to the potentially problematic functional status of the HME unit. Conversely, in any of the positions of the first state, the central region 300 is not visually perceptible, thus inherently indicating to a caregiver that the HME unit is not presenting an overt resistance to air flow.

Yet another embodiment of a resistance indicator 320 in accordance with principles of the present disclosure is illustrated in FIG. 15. The resistance indicator 320 includes tubing 322, a staining fluid 324, and filter discs 326, 328. Opposing legs 330, 332 of the tubing 322 are fluidly connected/exposed to pressure regions of interest of the corresponding HME unit (not shown) in a manner akin to previous embodiments. In this regard, the tubing legs 330, 332 can include an appropriate membrane (e.g., a hydrophobic/oilphobic membrane) 334 to prevent the staining fluid 324, otherwise contained within the tubing 322, from escaping. The tubing 322 is formed to assume a U-like shape (akin to a manometer), with the staining fluid 324 having a volume relative to a volume of the tubing 322 commensurate with that reflected in FIG. 15. Thus, upon final assembly, the staining fluid 324 effectively divides the legs 330, 332 into first and second chambers 336, 338, with the staining fluid 324 being akin to the membranes or diaphragms of the previous embodiments.

The filter discs 326, 328 are adhered within the tubing 322 as shown, with the tubing legs 330, 332 each forming a window 340 (akin to the windows previously described) in a region of the corresponding filter disc 326, 328. Thus, the filter discs 326, 328 are viewable through the tubing 322. The filter discs 326, 328 are chemically formulated in accordance with the staining fluid 324 such that when the staining fluid 324 contacts one of the filter discs 326, 328, the filter disc 326 or 328 changes colors (e.g., transitions from white to a different, bright color).

During use, the HME unit (not shown) to which the resistance indicator 320 is assembled functions as previously described, with the HME unit transmitting air flow/pressure to and from the patient. For example, the first leg 330 is fluidly connected to a pressure of interest, such as the ventilator-side port 58 (FIG. 5A), designated as “P1” in FIG. 15. The second leg 332 is also connected to a pressure of interest, such as adjacent the HM media 54 (FIG. 5C), designated as “P2” in FIG. 15. Under normal conditions, the pressure differential across the tubing 322 is such that the staining fluid 324 may slightly rise or drop relative to the tubing legs 330, 332; however, the staining fluid 324 level does not reach either of the filter discs 326, 328. Under excessive differential pressure conditions, the differential pressure across the tubing 322 will cause the staining fluid 324 to rise or flow along one of the legs 330 or 332 to a level commensurate with that of the corresponding filter disc 326 or 328. Contact between the staining fluid 324 and the filter disc 326 or 328 causes the filter disc 326 or 328 to change color. This change in color is visually perceptible by a caregiver via the corresponding window 340, alerting the caregiver to potentially problematic functioning of the HME unit. Conversely, a caregiver will readily understand that when the filter discs 326, 328 are of their original color or transparent, the HME unit is not overtly resisting flow.

Regardless of an exact design, the HME unit of the present disclosure provides a marked improvement over previous designs. By providing an “on-board” resistance indicator, a caregiver is quickly alerted to potentially problematic functioning of the HME unit (or proper operation of the HME unit) in terms of air flow/pressure resistance. Further, the HME unit is relatively inexpensive to manufacture, and is easily adapted to incorporate additional features such as filters, etc.

Although the present disclosure has been described with reference to preferred embodiments, workers skilled in the art will recognize that changes can be made in form and detail without departing from the spirit and scope of the present disclosure. For example, resistance indicators in accordance with the present disclosure can assume other forms, including mechanical or electromechanical constructions. Further, while the resistance indicator has been described as being fluidly located between the ventilator-side port and the HM media, other locations (e.g., adjacent the patient-side port) are also acceptable.

What is claimed is:

1. A heat and moisture exchange (HME) unit comprising:
a housing forming a first port, a second port, and an intermediate section extending between the first and second ports, the intermediate section defining a first flow path fluidly connecting the first and second ports;
a heat and moisture retaining media (HM media) maintained within the intermediate section along the first flow path; and
a resistance indicator carried by the housing and fluidly connected to the first port, wherein a visual appearance of the resistance indicator changes as a function of pressure differential within the housing.

2. The HME unit of claim 1, wherein the resistance indicator is configured to generate a change in visual appearance in response to an increase in differential pressure within the housing.

3. The HME unit of claim 2, wherein the resistance indicator is configured to change in visual appearance in response to a pressure differential within the housing exceeding a pre-determined pressure differential value.

4. The HME unit of claim 3, wherein the visual appearance of the resistance indicator changes in response to a pressure differential within the housing exceeding the pre-determined pressure differential value for a pre-determined time period.

5. The HME unit of claim 4, wherein the pre-determined pressure differential value is 5 cm water and the pre-determined time period is 0.5 second.

6. The HME unit of claim 1, wherein the resistance indicator provides a first state and a second state, a visual appearance of the resistance indicator in the first state differing from a visual appearance of the resistance indicator in the second state, and further wherein the resistance indicator is configured to transition from the first state to the second state in response to an increasing pressure differential within the housing.

7. The HME unit of claim 6, wherein the resistance indicator is configured such that upon transitioning to the second state, the resistance indicator remains in the second state regardless of a pressure differential within the housing.

8. The HME unit of claim 1, wherein the resistance indicator is fluidly connected to the first flow path.

9. The HME unit of claim 1, wherein the resistance indicator is fluidly disposed between the HM media and the first port.

10. The HME unit of claim 9, wherein the first port is a ventilator-side port and the second port is a patient-side port.

11. The HME unit of claim 1, wherein the resistance indicator includes:
a membrane defining a first face and a second face; and
a first chamber formed within the housing;
wherein the membrane is sealed within the housing such that the first face is fluidly open to the first chamber, and the second face is fluidly open to pressure indicative of flow resistance generated by the HM media.

12. The HME unit of claim 11, wherein the membrane includes a rim and a central section, the central section being deflectable relative to the rim.

13. The HME unit of claim 12, wherein the intermediate section of the housing further includes a second chamber fluidly connected to the first flow path, and further wherein the rim is sealed between the first and second chambers.

14. The HME unit of claim 12, wherein a spacing between the central section and the first chamber differs between the first and second states of the resistance indicator.

15. The HME unit of claim 14, wherein the central section defines an annular wall extending from the rim, and a button segment extending from the annular wall, and further wherein the resistance indicator further includes a flag mounted to the button segment and a longitudinal position of the flag relative to the rim is alterable by flexing of the annular wall.

16. The HME unit of claim 1, wherein an exterior of the resistance indicator is at least partially covered by a wall of the housing, and further wherein the wall is sufficiently transparent to permit viewing of the resistance indicator external the HME unit.

17. The HME unit of claim 1, wherein the intermediate section further defines a second flow path apart from the HM media, and further wherein the HME unit includes a valve mechanism including an obstruction member positioned to selectively close the second flow path.

18. The HME unit of claim 17, wherein the valve mechanism further includes a tab configured and arranged to selectively interface with the resistance indicator in transitioning the resistance indicator from a triggered state to an initial state.

19. A method of providing respiratory assistance to a patient, the method comprising:
providing a heat and moisture exchange (HME) unit including:
a housing forming a ventilator-side port, a patient-side port, and an intermediate section extending between the ports, the intermediate section defining a flow path fluidly connecting the ports,
a heat and moisture retaining media (HM media) maintained within the intermediate section along the flow path,
a resistance indicator carried by the housing and fluidly connected to the ventilator-side port, wherein a visual appearance of the resistance indicator changes as a function of differential pressure within the housing;
connecting the ventilator-side port to a source of pressurized gas;
connecting the patient-side port to a patient;
operating the source of pressurized gas to delivery air flow to the HME unit; and
alerting a caregiver, via the resistance indicator, to an excessive pressure differential condition in the HME unit.

20. The method of claim 19, wherein alerting a caregiver includes:
changing a visual appearance of the resistance indicator when a pressure differential within the HME unit exceeds a pre-determined pressure differential value.

21. The method of claim 20, wherein alerting a caregiver further includes:
changing a visual appearance of the resistance indicator when a pressure differential in the HME unit exceeds the pre-determined pressure differential value for a pre-determined time period.

22. The method of claim 20, wherein changing a visual appearance includes the resistance indicator transitioning from a first state to a second state.

23. The method of claim 22, wherein the resistance indicator includes a membrane sealed within the housing, the membrane including a rim and a central section, and further wherein transitioning from a first state to a second state includes the central section deflecting relative to the rim.

24. A method of manufacturing a heat and moisture exchange (HME) unit comprising:
providing a housing forming a first port, a second port, and an intermediate section;
assembling a heat and moisture retaining media (HM media) within the housing along a flow path fluidly connecting the first and second ports; and
assembling a resistance indicator to the housing such that the resistance indicator is fluidly connected to the first port;
wherein the resistance indicator is configured to experience a change in visual appearance as a function of a pressure differential within the housing.

25. The method of claim 24, wherein the housing is formed of a plastic material, the method further comprising:
polishing a portion of a wall of the housing adjacent the resistance indicator to render the wall portion sufficiently transparent for viewing of the resistance indicator from a point external the HME unit.

26. The method of claim 24, wherein assembling a resistance indicator includes connecting a flag to a membrane, and mounting the membrane within the housing.
